(19) United States
(12) Patent Application Publication
(10) Pub. No.: US 2025/0013675 A1
(43) Pub. Date: Jan. 9, 2025

(54) QUESTION MINING METHOD, ELECTRONIC DEVICE, AND NON-TRANSIROTY STORAGE MEDIA

(71) Applicant: MASHANG CONSUMER FINANCE CO., LTD., Chongqing (CN)

(72) Inventors: Hongyu ZHAO, Chongqing (CN); Bing XIAO, Chongqing (CN); Kexin LI, Chongqing (CN); Mingyao YANG, Chongqing (CN)

(73) Assignee: MASHANG CONSUMER FINANCE CO., LTD., Chongqing (CN)

(21) Appl. No.: 18/653,885

(22) Filed: May 2, 2024

(30) Foreign Application Priority Data
Jul. 7, 2023 (CN) 202310835676.1

(51) Int. Cl. G06F 16/332; G06F 16/35; G06F 40/289; G06F 40/35

(52) U.S. Cl. CPC G06F 16/3329; G06F 16/353; G06F 40/289; G06F 40/35

(57) ABSTRACT

A question-mining method includes obtaining a pre-built standard question database, where the standard question database includes a first standard question text, the first standard question text corresponds to a first intent category, and the first standard question text comprises a plurality of words; mining keywords of the first intent category from the plurality of words according to an importance degree of each word of the first standard question text to the first intent category, wherein the plurality of words include the keywords and non-keywords; determining a co-occurrence word of the keywords according to co-occurrence information of the keywords and the non-keywords in the standard question database; and mining a target question text from a pre-obtained target text set according to the co-occurrence word of the keywords.

### CROSS REFERENCE TO RELATED APPLICATIONS

The disclosure is a US national phase application which claims priority to Chinese patent application No. 202310835676.1 filed with the National Intellectual Property Administration on Jul. 7, 2023, which is incorporated by reference in the present application in its entirety.

### FIELD OF THE DISCLOSURE

The present disclosure relates to artificial intelligence technologies, in particular, to a question mining method, a device, an electronic device and a storage medium.

### BACKGROUND INFORMATION

The technology behind intelligent customer service is mainly based on dialogue interaction technology, and common dialogue tasks can be divided into small talk, task and question and answer. Among them, the most common one is the Q&A-type intelligent customer service system, that is, the Frequently Asked Questions (FAQ) system. When a customer asks a question, the system uses a rule engine, model matching and other technologies to identify the intent corresponding to the customer's question, and then automatically returns a pre-set answer based on the intent label (such as the intent number). The advantage of this system is that the quality of answers is relatively high, and the disadvantage is that the text matching technology of intent recognition is applied, and the standard question database (i.e., knowledge database) needs to be completely prepared.

The search-based Q&A system needs to be configured with some commonly used and clearly described questions, called “standard questions (text)”, which have a many-to-one mapping relationship between these standard questions and answers, and when the questions asked by the customer are matched to the standard questions, the corresponding answers are matched. The collection of standard questions forms the knowledge database, i.e. the standard question database. A common matching method is: when a customer asks a question, the FAQ system calculates the text similarity between the customer's question and all the configured standard questions to find the standard question that is most similar to the customer's question. When the question is accurately identified, the intent label corresponding to the question is obtained, and the predefined answer is returned. The main purpose of the standard question mining work is to improve the generalization ability of the FAQ system's intent recognition, so that the FAQ system can identify more complex and diverse questions.

The data used in standard question mining is mainly derived from the ASR text data generated by the Automatic Speech Recognition (ASR) technology when agents communicate with customers. However, due to the influence of the external environment and the performance of the ASR model, the generated ASR text data has problems such as long text and misrecognition, coupled with the randomness of people's dialogues and the large number of professional words, which brings certain difficulties to the standard question mining task.

### SUMMARY

One objective of an embodiment of the present disclosure is to provide a question mining method, a device, an electronic device and a storage medium, for efficiently and accurately mining high-quality question text from a large number of texts, thereby effectively expanding the standard question database.

According to an embodiment of the present disclosure, a question-mining method is disclosed. The method comprises: obtaining a pre-built standard question database, where the standard question database comprises a first standard question text, the first standard question text corresponds to a first intent category, and the first standard question text comprises a plurality of words; mining keywords of the first intent category from the plurality of words according to an importance degree of each word of the first standard question text corresponding to the first intent category; determining a co-occurrence word of the keywords according to co-occurrence information of the keywords and the non-keywords in the standard question database; and mining a target question text from a pre-obtained target text set according to the co-occurrence word of the keywords.

According to an embodiment of the present disclosure, an electronic device is disclosed. The electronic device comprises a processor and a memory electrically connected to the processor. The memory stores a computer program, and the processor is configured to execute the computer program stored the memory perform the aforementioned question mining method.

According to an embodiment of the present disclosure, a computer-readable storage medium is disclosed. The storage medium stores a computer program, and the computer program is executed by a processor to perform the aforementioned question mining method.

According to an embodiment, the present disclosure obtains a pre-built standard question database. The standard question database comprises a first standard question text, and the first standard question text corresponds to the first intent category. According to the importance degree of each word of the first standard question text to the first intent category, a plurality of words are selected from the first standard question text (including keywords and non-keywords) to mine the keywords of the first intent category. In addition, the present disclosure could determine the co-occurrence of keywords according to the co-occurrence information of the keywords and the non-keywords in the standard question database. Since keywords are mined based on the importance of each word of the first standard question text to the first intent category, the keywords can reflect the first intent category of the first standard question text to a certain extent. Since the co-occurrence of keywords is determined based on the co-occurrence information of the keyword and the co-occurrence word of the standard question database, where the co-occurrence information is the information that appears in the same text. Therefore, the co-occurrence of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. For example, the same target question text includes both keywords and their co-occurrences, so that the keywords and co-occurrence words in the target question text can accurately reflect the corresponding intent categories of the target question text. Therefore, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question database.

### BRIEF DESCRIPTION OF THE DRAWINGS

In order to clearly illustrate the technical solutions in one or more embodiments or prior art of the present disclosure, the drawings required to be used in the description of the embodiments or prior art will be briefly described below, and it is obvious that the drawings described below are only some embodiments described in one or more embodiments of the present disclosure, and other drawings may be obtained from those drawings without creative labor for those skilled in the art.

FIG. 1 is a flow chart of a question mining method according to an embodiment of the present disclosure.

FIG. 2 is a block diagram of a question mining device according to an embodiment of the present disclosure.

FIG. 3 is a block diagram of an electronic device according to an embodiment of the present disclosure.

### DETAILED DESCRIPTION

The embodiment of the application provides a problem mining method, a device, an electronic device and a storage medium to efficiently and accurately mine high-quality problem text from a large number of texts, thereby effectively expanding the standard question library.

In order to enable persons in the art to better understand the technical solutions in the present disclosure, the technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments obtained by a person skilled in the art without creative work shall fall within the scope of protection of the present disclosure.

In the field of intelligent question answering technology, the mining of standard question text is difficult. Standard problem texts are mined using EDA (Easy Data Augmentation) methods or open-source BERT-related models (such as Simbert models). Among them, the EDA method is mainly composed of four simple but powerful operations, including synonym substitution, random insertion, random swap, and random deletion. One way to do this is to obtain a new question text by replacing words in an existing standard question text with synonyms, or to obtain a new question text by randomly inserting words, phrases, etc. into an existing standard question text. For example, the existing standard question text is “the interest rate is so high”, and through the EDA method, the new question text is excavated as follows: “the bank has such a high interest rate”, “the interest rate is so high”, “if the interest rate is so high”, and so on. It can be seen that due to the simplicity of the EDA method, it is easy to generate illogical problem text, which leads to semantic errors in the generated problem text. If you want to generate logically accurate question text, you need to involve human beings (e.g., operational personnel), such as manually removing question text with semantic errors, which obviously greatly increases the workload of operational personnel and is less efficient.

BERT-related models, such as the Simbert model, are based on the open-source BERT model and are trained using a large number of standard question texts. Although the BERT model can generate sentences with strong semantic expression ability, due to the limitations of the model itself, it cannot generate more information-rich and diverse standard question texts. For example, the existing standard question text is “the interest rate is so high”, and the new questions based on the BERT-related model are as follows: “why is the interest rate so high”, “why is the interest rate so high now”, and so on. It can be seen that the information in the question text mined by the BERT-related model is not rich and diverse enough, so the generalization ability is insufficient, which is not helpful to improve the performance of the intent recognition model.

Based on the above issues, the preset disclosure provides a question mining method by obtaining a pre-built standard question database, which comprises a first standard question text, and the first standard question text corresponds to the first intent category. According to the importance of each word of the first standard question text to the first intent category, the keywords of the first intent category were mined from multiple words (including keywords and non-keywords) in the first standard question text, and the co-occurrence words of the keywords were determined according to the co-occurrence information of keywords and non-keywords in the standard question database. Since keywords are mined based on the importance of each word of the first standard question text to the first intent category, the keywords can reflect the first intent category of the first standard question text to a certain extent. The co-occurrence of keywords is determined based on the co-occurrence information of the keyword and the co-occurrence word of the standard question database, the co-occurrence information is the information that appears in the same text. Therefore, the co-occurrence word of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. From the above, it can be seen that the mining of target question text sufficiently refers to the keywords representative to the intent category of the standard question text and the co-occurrence words of the keywords. For example, the same target question text includes both keywords and their co-occurrence words, so that the keywords and co-occurrence words in the target question text can accurately reflect the corresponding intent categories of the target question text. Thus, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question library.

According to an embodiment, the question mining method can be performed by an electronic device or by software installed in an electronic device. Specifically, the electronic device may be a terminal device or a server-side device. Here, the terminal device may include smart phones, laptops, smart wearable devices, vehicle terminals, etc., and server device may include independent physical servers, server clusters composed of multiple servers, or cloud servers capable of cloud computing.

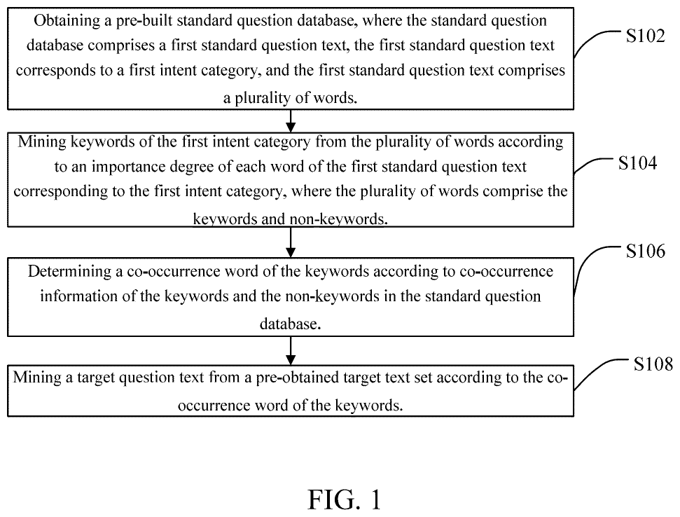

Please refer to FIG. 1. FIG. 1 is a flow chart of a question mining method according to an embodiment of the present disclosure. As shown in FIG. 1, the method comprises following steps:

S102: obtaining a pre-built standard question database; wherein the standard question database comprises a first standard question text, the first standard question text corresponds to a first intent category, and the first standard question text comprises a plurality of words.

The standard question database may include N standard question texts, and N is an integer greater than 1. Optionally, multiple standard question texts can correspond to the same intent category among N standard question texts. Each intent category can have a unique intent label (such as an intent number), and there is a one-to-one correspondence between the intent label and the answer. Therefore, in the case where N standard question texts correspond to the same intent category, the answer to each standard question text in the N standard question texts is the same. N standard question texts can also correspond to different categories of intent.

The first intent category can be any of the intent categories corresponding to the standard question database. The first standard question text is one or more standard question texts in the standard question database that correspond to the first intent category.

S104: mining keywords of the first intent category from the plurality of words according to an importance degree of each word of the first standard question text to the first intent category; wherein the plurality of words comprise the keywords and non-keywords.

The importance (degree) of each word to the first intent category can be characterized by a specific numerical value. The higher the value of the importance of the word to the first intent category, the higher the importance degree of the word to the first intent category. This embodiment does not limit the form of the value of the importance degree. For example, it may be in the form of a percentage, an integer, and the like. Optionally, the importance degree of each word to the first intent category may be based on the occurrence information (such as the number of occurrences, frequency of occurrences, etc.) of each word of the first standard question text, and/or based on the occurrence information (e.g., number of occurrences, frequency of occurrence, etc.) of each word of the entire standard question database (i.e., N standard question texts). The number of occurrences of a word of the text (i.e., the first standard question text or the N standard question texts) is the number of occurrences of the word of the text. The frequency of occurrence of the word of the text (i.e., the first standard question text or N standard question texts) is the proportion of the number of occurrences of the word of the text to the total number of all words in the text. For example, if the text includes a total of 10 words and a specific word appears 3 times in the text, then the frequency of that word of the text is 0.3.

For example, when representing the importance degree of a word of the first standard question text based on the number of occurrences of the word of the first standard question text, the number of occurrences of the word of the first standard question text can be determined, and then the number of occurrences can be determined as the value of the importance degree of the word to the first intent category. Assuming that the number of occurrences of the word of the text of the first standard question is 3, the value of the importance degree of the word to the first intent category is 3. Alternatively, a value for the importance degree of the word to the first intent category may be calculated based on the number of occurrences of the word of the first standard question text and a preset calculation method (e.g., a formula). The specific calculation of the importance degree of each word to the first intent category is described in detail in the following embodiments.

Before executing the step S104, a word segmentation of the first standard question text can be performed by using a word segmenter, so that all words in the first standard question text are obtained. Optionally, all words in the first standard question text may be preprocessed, such as by removing stop words and retaining necessary nouns, pronouns, verbs, prepositions, adjectives, and words commonly used in business.

Step 106: determining a co-occurrence word of the keywords according to co-occurrence information of the keywords and the non-keywords in the standard question database.

Here, the co-occurrence information is the information that the keyword and the non-keyword appear together, such as the number of co-occurrences, the frequency of co-occurrence, etc. Optionally, when the keyword appears in the same standard question text as the non-keyword, the keyword and the non-keyword may be considered to co-occur, and the non-keyword co-occurring with the keyword is the co-occurrence of the keyword.

S108: mining a target question text from a pre-obtained target text set according to the co-occurrence word of the keywords.

Here, the target text set includes multiple question texts.

In this embodiment, the target text set comprises a plurality of dialogue texts, and the dialogue text comprises a question text and an answer text. The dialogue text of the target text set can be the historical dialogue text between the customer and the agent in the current scenario, which refers to the scenario corresponding to the standard question database, i.e. the scenario related to the standard question text in the standard question database. For example, if the scenario corresponding to the standard question database is the telemarketing scenario, then the current scenario is the telemarketing scenario, and the dialogue text in the target text set can include the dialogue text between the customer and the agent in the telemarketing process.

According to an embodiment, the present disclosure obtains a pre-built standard question database. The standard question database comprises a first standard question text, and the first standard question text corresponds to the first intent category. According to the importance degree of each word of the first standard question text to the first intent category, a plurality of words are selected from the first standard question text (including keywords and non-keywords) to mine the keywords of the first intent category. In addition, the present disclosure could determine the co-occurrence of keywords according to the co-occurrence information of the keywords and the non-keywords in the standard question database. Since keywords are mined based on the importance of each word of the first standard question text to the first intent category, the keywords can reflect the first intent category of the first standard question text to a certain extent. The co-occurrence of keywords is determined based on the co-occurrence information of the keyword and the co-occurrence word of the standard question database, where the co-occurrence information is the information that appears in the same text. Therefore, the co-occurrence of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. For example, the same target question text includes both keywords and their co-occurrences, so that the keywords and co-occurrence words in the target question text can accurately reflect the corresponding intent categories of the target question text. Therefore, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question database.

In one embodiment, according to the importance (degree) of each word of the first standard question text to the first intent category, when the key words of the first intent category are mined from a plurality of words in the first standard question text, the following steps A1-A4 can be specifically performed:

Step A1: determining a target long text corresponding to the first intent category according to the first standard question text; wherein the target long text comprises at least one first standard question text.

The first standard question text corresponding to the first intent category may include one or more. Typically, the first intent category corresponds to more than one first standard question texts. When determining the target long text corresponding to the first intent category, firstly, one or more representative first standard question texts are selected from the plurality of first standard question texts corresponding to the first intent category, and then one or more first standard question texts are spliced together to obtain the target long text corresponding to the first intent category. Here, the representative first standard question text can be the first standard question text with clear semantic logic (i.e., high text quality).

Optionally, there is a case where there is a first standard question text with a large text difference among the plurality of first standard question texts corresponding to the first intent category, i.e., the textual similarity between the first standard question texts is low. In this case, a balanced screening method can be used to filter a number of representative first standard question texts from the first standard question texts corresponding to the first intent category. The purpose of balanced screening is to make the number of first standard question texts with high similarity as similar as possible among the representative first standard question texts screened for the first intent category. Then, the target long text is determined based on the balanced screened first standard question texts.

For example, Table 1 below illustrates the correspondence between the different intent categories and the standard question text. The intent categories in Table 1 can be the first intent category or other intent categories, and the standard question text can be the first standard question text or other standard question texts corresponding to other intent categories. As shown in Table 1, the standard question text corresponding to numbers 1-6 corresponds to the intent category “temporarily unable to repay the money”, and the standard question text corresponding to Nos. 7-9 corresponds to the intent category “at work now, will handle it later”. Among the standard question texts corresponding to numbers 1-6, the text similarity between the standard question texts corresponding to numbers 1-3 is higher, and the text similarity between the standard question texts corresponding to numbers 4-6 is higher. It can be seen that among the multiple standard question texts screened out in a balanced manner, the number of standard question texts with high similarity is 3. Then, by splicing together the standard question text corresponding to numbers 1-6, the target long text corresponding to the intent category “temporarily unable to repay the money” can be obtained. In the same way, target long text corresponding to the intent category “Work Later at Work” can be obtained by splicing together the standard question text corresponding to numbers 7-9. It should be noted that the example shown in Table 1 is only an illustrative approach and does not limit the number of standard question texts that form the target long text. In order to make the mining of standard question text more balanced and accurate, the text length of the target long text corresponding to each intent category should be the same or close as possible. The text length of the target long text can be determined based on the number of standard question texts that form the target long text. For example, the target long text corresponding to each intent category is spliced together from 10 standard question texts. The text length of the target long text can also be determined based on the total number of words in the target long text. For example, the total text count of the target long text corresponding to each intent category is between 50-60 words.

TABLE 1

| numbering | Standard question text | Intent Category |
|---|---|---|
| 1 | I don't have any money right | temporarily unable to |
| | now | repay the money |
| 2 | I can't handle it right now | |
| 3 | I don't really have any money | |
| 4 | Wait a few days before | |
| | processing | |
| 5 | Wait a few days to repay it | |
| 6 | Let's talk about it in a few days | |
| | when I have money | |
| 7 | I'm at work | at work now, will |
| 8 | I'm at work, I'll wait to pay it | handle it later |
| | back | |
| 9 | I'll pay it back when I get off | |
| | work | |

Step A2: determining a first occurrence information of each word of the target long text in the target long text, and determining a second occurrence information of each word of the target long text in the standard question database.

The target long text can be segmented through a word segmenter, so that each word of the target long text can be determined.

Step A3: determining the importance degree of each word of the target long text to the first intent category according to the first occurrence information and the second occurrence information.

Step A4: mining the keywords of the first intent category from the plurality of words according to the importance degree of each word of the target long text to the first intent category; wherein the keywords are words whose importance degree is higher than or equal to a preset importance degree threshold.

Optionally, the first occurrence information includes the frequency of occurrence. Based on this, when determining the first occurrence information of each word of the target long text, as to the first word, the first occurrence number (number of occurrence) of the first word of the target long text can be determined, and then the occurrence frequency of the first word of the target long text can be determined according to the first occurrence number and the total number of words included in the target long text. The first word could be any word of the target long text corresponding to the first intent category.

The second occurrence information comprises an inverse document frequency. Based on this, when determining the second occurrence information of each word of the target long text in the standard question database, as to the second word, the first text number in all target long texts including the second word in all target long texts can be determined. Here, all target long texts refer to the target long texts corresponding to all intent categories corresponding to the standard question database, and the second word is any word of the target long text corresponding to the first intent category. Then, based on the first text number and the total text number of the target long text, the inverse document frequency corresponding to the second word is determined. In particular, since each intent category corresponding to the standard question database corresponds to only one target long text, the total text number of the target long texts is equal to the total number of the intent categories corresponding to the standard question database.

For the target long text corresponding to the first intent category, after determining the occurrence frequency of each word of the target long text in the target long text and the inverse document frequency of each word of the target long text in the standard question database, the importance degree of each word of the target long text to the first intent category is determined based on the occurrence frequency and inverse document frequency.

Optionally, the improved TF-IDF algorithm is used to determine the importance degree of each word of the target long text to the first intent category. In the improved TF-IDF algorithm, TF represents the word frequency, i.e. the frequency of the word of the target long text; and IDF indicates the inverse document frequency of the word in N standard question texts.

First, the word frequency is calculated, and the occurrence frequency of the word of the target long text can be calculated using the following equation (1):

$${TF}_{i , j} = \frac{{N}_{i , j}}{{\sum }_{k} {N}_{k , j}} , \qquad ( 1 )$$

where i represents any word of the target long text. Here, the occurrence frequency of the word i in the target long text is currently being calculated. j represents the target long text where the word i is located, and k represents every word of the target long text. TF_{i,j} indicates the frequency of word i in the target long text j. N_{i,j} indicates the occurrence number of word i of the target long text j. ΣₖN_{k,j} represents a sum of the occurrence number of each word of the target long text j in the target long text j, which is equal to the total number of words of the target long text j.

Then the inverse document frequency of the word is calculated using the following equation (2):

$${IDF}_{i} = log ( \frac{D}{1 + \vert {D}_{i} \vert} ) , \qquad ( 2 )$$

where i represents any word of the target long text. Here, the inverse document frequency of the word i is to be calculated in the standard question database. j indicates the target long text where the word i is located. IDFᵢ indicates the inverse document frequency of the word i in the standard question database. D represents the total number of the target long texts. |Dᵢ| represents the number of first texts in all target long texts that include the word i.

For the target long text corresponding to the first intent category, after calculating the frequency of each word of the target long text in the target long text and the inverse document frequency of each word of the target long text in the standard question database, the importance degree of each word of the target long text to the first intent category can be calculated according to the following equation (3):

$${P}_{i} = {TF}_{i , j} * {IDF}_{i} \qquad ( 3 )$$

where Pᵢ represents the importance degree of the word i to the first intent category. In other words, the importance degree of a word to the first intent category is the product of the occurrence frequency of the word of the target long text corresponding to the first intent category and the inverse document frequency of the word of the standard question database.

According to the method of the above embodiment, the keywords of each intent category corresponding to the standard question database can be determined. Optionally, the number of keywords n (n is a positive integer) of each intent category can be predetermined, so that the words in the top n positions of importance degree can be selected as the keywords of the intent category according to the order of importance degree.

In one embodiment, the co-occurrence information of keywords and non-keywords in the standard question database includes co-occurrence. The standard question database comprises N standard question texts, and N is an integer greater than 1. To determine the co-occurrence of keywords based on the co-occurrence information of keywords and non-keywords in the standard question database, the following steps B1-B3 could be performed:

Step B1: determining a second text number of the standard question text that includes the keywords in N standard question texts; and determining a third text number of the standard question texts that include both the keywords and the non-keywords in the N standard question texts.

Step B2: determining the co-occurrence degree of the keywords and the non-keywords in the standard question database according to the second text number, the third text number and the total number of the N standard question texts.

Step B3: determining that the non-keywords as the keywords when the co-occurrence degree of the keywords and the non-keywords is greater than or equal to a preset threshold.

Optionally, the Point-wise mutual information (PMI) method is used to calculate the co-occurrence of keywords and non-keywords in the standard question database. The purpose of the PMI method is to find words that appear at the same time as keywords, which can be calculated according to the following equations (4)-(6):

$$PMI ( i , j ) = log \frac{p ( i , j )}{p ( i ) p ( j )} \qquad ( 4 )$$

$$p ( i , j ) = \frac{M ( i , j )}{N} \qquad ( 5 )$$

$$p ( i ) = \frac{M ( i )}{N} \qquad ( 6 )$$

where PMI(i,j) represents the co-occurrence of the keyword i and the non-keyword j in the standard question database, N represents the total number of texts in N standard question texts. M(i) represents the number of second texts of standard question texts that include keyword i in N standard question texts. M(i,j) represents the number of third texts of standard question texts that include both the keyword i and the non-keyword j in N standard question texts. p(j) and p(i) can be calculated according to the same equations (6), and the difference between them is the difference of the words.

After calculating the co-occurrence of keywords and non-keywords in the standard question base, the co-occurrence of non-keywords with keywords greater than or equal to the preset co-occurrence threshold is determined to be the co-occurrence of keywords. Optionally, when the value of PMI(i,j) is positive, it means that there is a certain co-occurrence correlation between the keyword i and the non-keyword j. The higher the value PMI(i,j), the more it indicates that the keyword i and the non-keyword j have co-occurrence. Assuming that the default co-occurrence threshold is 0.5, the non-keyword j corresponding to the value PMI(i,j) greater than or equal to 0.5 is filtered out from all of them to be the co-occurrence words of the keyword i.

In one embodiment, when Step S108 of mining a target question text from a pre-obtained target text set according to the co-occurrence word of the keywords is executed, the following steps can be executed:

First, a candidate question text is screened from the target text set; wherein the candidate question text is a question text that include both the keywords and the non-keywords.

If a keyword corresponds to only one co-occurrence word, the candidate question text is the question text that includes both the keyword and the co-occurrence word. If a keyword includes multiple co-occurrence words, the question text that includes both the keyword and at least one co-occurrence word of the keyword can be identified as candidate question text. Or, the question text that includes both the keyword and all co-occurrence words of the keyword is identified as the candidate question text.

Then, the intent category to which the candidate question text belongs is predicted to obtain a prediction result of the candidate question text.

And then, whether the candidate question text is the target question text is determined according to the prediction result.

In this embodiment, the prediction result may include at least one of the following: the first prediction intent category, the probability that the candidate question text belongs to each intent category.

Optionally, the text length range of the candidate question text can be preset to filter out a candidate question text that is not within the text length range, and then the target question text is determined based on the filtered candidate question text.

Table 2 below lists the correspondences between the keywords, co-occurrence words, and candidate question texts corresponding to the first intent category “repay after getting my paycheck”. It can be seen that the candidate question text includes both keywords and co-occurrence words of keywords.

TABLE 2

| | | Co- | |
|---|---|---|---|
| Intent | | occurrence | |
| Category | keyword | words | Candidate question text |
| repay after | paycheck | Get | I said I would wait until I get |
| getting my | | | my paycheck this month |
| paycheck | salary | Get | I'll pay it back next month when |
| | | | I get paid my salary |
| | Get | Also/process/ | I will transfer the money when I |
| | money | transfer | get my paycheck in these days |
| | Send | Also/process/ | I will send the money when I get |
| | money | transfer | my money tomorrow |
| | . . . | . . . | . . . |

When a keyword has multiple co-occurrence words, if the candidate question text needs to include both the keyword and all the co-occurrence words of the keyword, the greater the number of co-occurrence words, the stricter the constraints on the candidate question text, and the higher the accuracy of the candidate question text.

In this embodiment, the prediction result of the candidate question text is obtained by predicting the intent category to which the candidate question text belongs, and then whether the candidate question text is the target question text is determined according to the prediction result. The purpose of this is to further check and screen the candidate question texts, so as to screen out the high-quality target question texts that are helpful for improving the generalization ability of the intent recognition model, and make the mining results of the standard question texts more accurate and diverse.

In one embodiment, the prediction result comprises a first prediction intent category. When the intent category of the candidate question text is predicted and the prediction result of the candidate question text is obtained, the following steps C1-C4 can be executed:

Step C1: clustering N standard question texts to obtain a clustering result, wherein the clustering result comprises a plurality of question text sets, and each of the question text sets comprise a plurality of the standard question texts.

Here, any of the existing clustering algorithms can be used to cluster N standard question texts. For example, the k-means clustering algorithm can be used, and the k value in the algorithm can be greater than or equal to the total number of intent categories corresponding to the standard question database, and the number of standard question texts in each cluster cannot be lower than the preset threshold. Before clustering, the standard question text vectors corresponding to each standard question text in the N standard question texts can be determined based on the existing vector representation methods, and then the N standard question text vectors can be clustered. K clusters correspond to K question text sets, and the standard question texts corresponding to the standard question text vectors in each cluster form a question text set. Here, the standard question database includes N standard question texts, and N is an integer greater than 1.

Step C2: determining a central question text for each of the question text sets, wherein the central question text is the standard question text closest to a clustering center corresponding to the question text set.

The above-mentioned k-means clustering algorithm could be used for clustering. After clustering, K clusters and the clustering center (i.e., the center vector) of each cluster can be obtained, so that the standard question text corresponding to the standard question text vector closest to the cluster center in each cluster can be determined as the central question text. K clusters correspond to K central question texts.

Step C3: from a plurality of central question texts, selecting a central question text with a highest degree of similarity with the candidate question text.

In this step, when calculating the similarity between the candidate question text and the K central question texts, the vector distance between the text vectors corresponding to the candidate question text and the text vectors corresponding to each central question text can be calculated, and then the text vector corresponding to the central question text with the shortest vector distance between the text vectors corresponding to the candidate question text is determined according to the vector distance. In this way, the central question text with the highest similarity could be identified. The vector distance is inversely proportional to the similarity.

Step C4: determining the intent category of the central question text with the highest similarity with the candidate question text as the first prediction intent category.

In the K central question texts, each central question text corresponds to a unique intent category. Assuming that the central question text with the highest similarity with the candidate question text among the K central question texts is the text A, then the intent category of the text A is the first predictive intent category.

Optionally, when determining whether the candidate question text is the target question text according to the first prediction intent category, if the first prediction intent category and the intent category corresponding to the keyword are the same, the candidate question text is determined to be the target question text. If the intent category of the first prediction and the intent category corresponding to the keyword are different, the candidate question text is determined not to be the target question text.

In this embodiment, if the first prediction intent category and the intent category corresponding to the keyword are different, it indicates that there is a semantic anomaly in the candidate question text, such as semantics that do not conform to logic. By filtering out the candidate question texts with different intent categories corresponding to the first prediction intent category and the keyword, it is impossible for the final target question text to have semantic anomalies, so as to ensure the high quality of the target question text.

In one embodiment, if the first predicted intent category of the candidate question text and the intent category corresponding to the keyword are the same, the candidate question text may be retained first. That is, when the first predicted intent category of the candidate question text and the intent category corresponding to the keyword are the same, the candidate question text is not directly determined as the target question text. Instead, this candidate question text is further screened to determine the target question text with higher quality.

In one embodiment, the prediction result comprises: the probability that the candidate question text belongs to each intent class. When the intent category to which the candidate question text belongs is predicted and the prediction result corresponding to the candidate question text is obtained, the pre-trained intent recognition model can be used to predict the intent category to which the candidate question text belongs, and the probability that the candidate question text belongs to each intent category is obtained. Here, the intent recognition model is trained according to the sample question text and the sample intent category of the sample question text. Since the intent recognition model is an existing model, the specific model training process will not be explained in detail.

In this embodiment, in the process of predicting the intent category to which the candidate question text belongs, the predicted candidate question text may be all candidate question texts screened from the target text set. That is, the target question text set could comprise the question texts including the keywords and co-occurrence words of keywords. It can also be candidate question text that has been retained after being filtered based on the first predicted intent category.

Optionally, when determining whether the candidate question text is the target question text according to the prediction result, the information entropy of the candidate question text can be calculated according to the probability that the candidate question text belongs to each intent category. If the information entropy is greater than or equal to the preset information entropy threshold, the candidate question text is determined to be the target question text. If the information entropy is less than the preset information entropy threshold, the candidate question text is determined not to be the target question text.

The formula for calculating information entropy can be expressed as the following equation (7):

$$H ( X ) = - \sum p ( {x}_{i} ) log ( p ( {x}_{i} ) ) \qquad ( 7 )$$

where X represents the candidate question text for the current calculation. Assuming that there are n intent categories in total, and different intent categories are denoted as (x₁, x₂, . . . , xₙ) then in equation (7), the p(xᵢ) represents the probability that the candidate question text belongs to the intent category xᵢ, where i=1, 2 . . . , n. And, the Σp(xᵢ) value is 1. That is, for the same candidate question text, the sum of the probabilities of each intent category is 1.

In this embodiment, the information entropy can be directly related to the amount of semantic information of the candidate question text and its uncertainty to a certain extent. That is, the measure of the amount of semantic information is equal to the amount of uncertainty. By inputting the candidate standard questions into the intent recognition model, the information entropy of the candidate question texts is calculated based on the predicted probabilities when the probability that the candidate question texts belong to each intent category is obtained. The larger the value of information entropy, the more difficult it is for the intent recognition model to predict the candidate question text, and the higher the possibility of the candidate question text for improving the generalization ability of the intent recognition model. Therefore, by identifying the candidate question text with large information entropy (i.e., greater than or equal to the preset information entropy threshold) as the target question text, the final target question text can be conducive to improving the generalization ability of the intent recognition model.

In sum, specific embodiments of the present disclosure have been described. Other embodiments are within the scope of the claims. In some cases, the actions described in the claims can be performed in a different order and still achieve the desired result. In addition, the process depicted in the drawings does not necessarily require a specific or continuous sequence shown in order to achieve the desired result. In some embodiments, multitasking and parallel processing can be advantageous. All these changes fall within the scope of the present disclosure.

According to an embodiment of the present disclosure, a question mining device is disclosed.

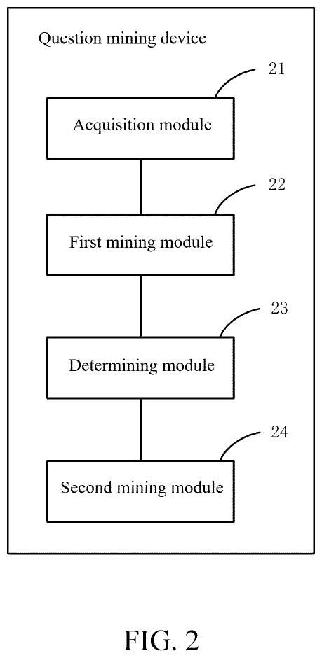

Please refer to FIG. 2. FIG. 2 is a block diagram of a question mining device according to an embodiment of the present disclosure. The question mining device comprises an acquisition module 21, a first mining module 22, a determining module 23 and a second mining module 24.

The acquisition module 21 is configured for obtaining a pre-built standard question database; wherein the standard question database comprises a first standard question text, the first standard question text corresponds to a first intent category, and the first standard question text comprises a plurality of words;

The first mining module 22 is configured for mining keywords of the first intent category from the plurality of words according to an importance degree of each word of the first standard question text to the first intent category. The plurality of words comprise the keywords and non-keywords.

The determining module 23 is configured for determining a co-occurrence word of the keywords according to co-occurrence information of the keywords and the non-keywords in the standard question database.

The second mining module 24 is configured for mining a target question text from a pre-obtained target text set according to the co-occurrence word of the keywords.

When the operation of mining keywords of the first intent category from the plurality of words according to the importance degree of each word of the first standard question text to the first intent category is performed, the first mining module 22 is configured for performing operations including:
determining a target long text corresponding to the first intent category according to the first standard question text, where the target long text comprises at least one first standard question text;
determining a first occurrence information of each word of the target long text in the target long text, and determining a second occurrence information of each word of the target long text in the standard question database;
determining the importance degree of each word of the target long text to the first intent category according to the first occurrence information and the second occurrence information;
mining the keywords of the first intent category from the plurality of words according to the importance degree of each word of the target long text to the first intent category, wherein the keywords are words whose importance degree is higher than or equal to a preset importance degree threshold.

In another embodiment of the present disclosure, the first occurrence information comprises an occurrence frequency. When the operation of determining the first occurrence information of each word of the target long text in the target long text is performed, the first mining module 22 is configured for performing operations including:
determining a first occurrence number of a first word of the target long text; wherein the first word is any word of the target long text; and
determining the occurrence frequency of the first word of the target long text according to first occurrence number and a total number of words included in the target long text.

In another embodiment of the present disclosure, the second occurrence information comprises an inverse document frequency. When the operation of determining the second occurrence information of each word of the target long text in the standard question database is performed, the first mining module 22 is configured for performing operations including:
determining a first text number of the target long text corresponding to each intent category in the standard question database that includes a second word;
determining the inverse document frequency corresponding to the second word according to the first text number and a total number of texts of the target long text.

In another embodiment of the present disclosure, the co-occurrence information comprises a co-occurrence degree. When the operation of determining a co-occurrence word of the keywords according to the co-occurrence information of the keywords and the non-keywords in the standard question database is performed, determining module 23 is configured for performing operations including:
determining a second text number of the standard question text that includes the keywords in N standard question texts; and determining a third text number of the standard question texts that include both the keywords and the non-keywords in the N standard question texts;
determining the co-occurrence degree of the keywords and the non-keywords in the standard question database according to the second text number, the third text number and the total number of the N standard question texts;
determining that the non-keywords as the keywords when the co-occurrence degree of the keywords and the non-keywords is greater than or equal to a preset threshold.

In another embodiment of the present disclosure, when the operation of mining the target question text from the pre-obtained target text set according to the co-occurrence word of the keywords is performed, the second mining module 24 is configured for performing operations including:
screening a candidate question text from the target text set; wherein the candidate question text is a question text that include both the keywords and the non-keywords;
predicting the intent category to which the candidate question text belongs, and obtaining a prediction result of the candidate question text;
determining whether the candidate question text is the target question text according to the prediction result.

In another embodiment of the present disclosure, the prediction result comprises a first prediction intent category. When the operation of predicting the intent category to which the candidate question text belongs and obtaining a prediction result of the candidate question text is performed, the second mining module 24 is configured for performing operations including:
clustering N standard question texts to obtain a clustering result, wherein the clustering result comprises a plurality of question text sets, and each of the question text sets comprise a plurality of the standard question texts;
determining a central question text for each of the question text sets, wherein the central question text is the standard question text closest to a clustering center corresponding to the question text set;
from a plurality of central question texts, selecting a central question text with a highest degree of similarity with the candidate question text;
determining the intent category of the central question text with the highest similarity with the candidate question text as the first prediction intent category.

In another embodiment of the present disclosure, when the operation of determining whether the candidate question text is the target question text according to the prediction result is performed, the second mining module 24 is configured for performing operations including:
when the first prediction intent category and the intent category corresponding to the keyword are the same, determining the candidate question text as the target question text; and
when the first prediction intent category and the intent category corresponding to the keyword are different, determining the candidate question text not to be the target question text.

In another embodiment of the present disclosure, the prediction result comprises a probability that the candidate question text belongs to each intent category. When the operation of predicting the intent category to which the candidate question text belongs, and obtaining an prediction result of the candidate question text is performed, the second mining module 24 is configured for performing operations including:
using a pre-trained intent recognition model to predict the intent category to which the candidate question text belongs, and obtaining the probability that the candidate question text belongs to each intent category. The intent recognition model is obtained by training according to sample question texts and sample intent categories of the sample question texts.

In another embodiment of the present disclosure, when the operation of determining whether the candidate question text is the target question text according to the prediction result is performed, the second mining module 24 is configured for performing operations including:
calculating an information entropy of the candidate question text according to the probability that the candidate question text belongs to each intent category;
when the information entropy is greater than or equal to the preset information entropy threshold, determining the candidate question text to be the target question text;
when the information entropy is less than the preset information entropy threshold, determining the candidate question text not to be the target question text.

By utilizing the question mining device according to an embodiment, the present disclosure obtains a pre-built standard question database. The standard question database comprises a first standard question text, and the first standard question text corresponds to the first intent category. According to the importance degree of each word of the first standard question text to the first intent category, a plurality of words are selected from the first standard question text (including keywords and non-keywords) to mine the keywords of the first intent category. In addition, the present disclosure could determine the co-occurrence of keywords according to the co-occurrence information of the keywords and the non-keywords in the standard question database. Since keywords are mined based on the importance of each word of the first standard question text to the first intent category, the keywords can reflect the first intent category of the first standard question text to a certain extent. Since the co-occurrence of keywords is determined based on the co-occurrence information of the keyword and the co-occurrence word of the standard question database, where the co-occurrence information is the information that appears in the same text. Therefore, the co-occurrence of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. For example, the same target question text includes both keywords and their co-occurrences, so that the keywords and co-occurrence words in the target question text can accurately reflect the corresponding intent categories of the target question text. Therefore, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question database.

Those skilled in the art should be able to understand that the question mining device in FIG. 2 can be used to realize the question mining method described above, and the detailed description thereof should be similar to the description of the method part above, and thus omitted here.

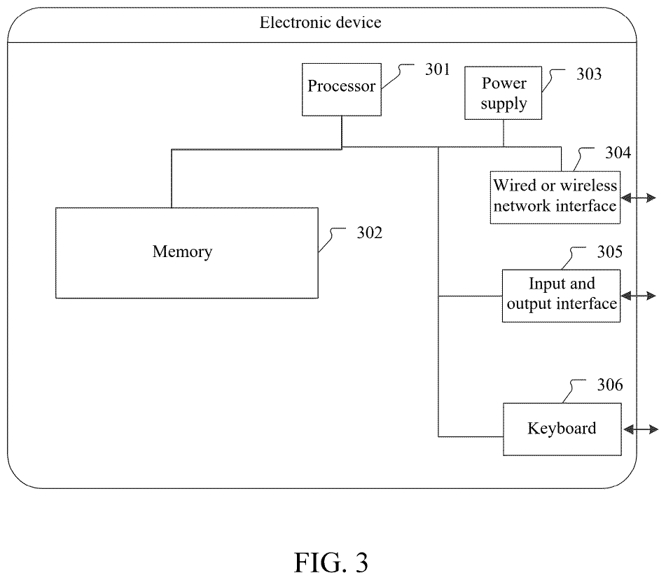

According to an embodiment of the present disclosure, an electronic device is disclosed. Please refer to FIG. 3. FIG. 3 is a block diagram of an electronic device according to an embodiment of the present disclosure. The electronic device can vary greatly depending on configuration or performance, and may include one or more processors 301 and memory 302. The memory 302 can store one or more storage applications or data. Here, the memory 302 can be a volatile or non-volatile memory. Applications stored in the memory 302 may include one or more modules (not shown in the figure). Each module may include a series of computer-executable instructions to an electronic device. Furthermore, the processor 301 can be programmed to communicate with the memory 302 to execute a series of computer-executable instructions in the memory 302 on an electronic device. The electronic device may also include one or more power supplies 303, one or more wired or wireless network interfaces 304, one or more input/output interfaces 305, and one or more keyboards 306.

Specifically, in this embodiment, the electronic device comprises a memory and one or more programs. The one or more programs are stored in the memory and may include one or more modules. Each module may include executable instructions to the electronic device, and is configured to be executed by one or more processors to execute the one or more programs to perform operations comprising:
obtaining a pre-built standard question database; wherein the standard question database comprises a first standard question text, the first standard question text corresponds to a first intent category, and the first standard question text comprises a plurality of words;
mining keywords of the first intent category from the plurality of words according to an importance degree of each word of the first standard question text to the first intent category, wherein the plurality of words comprise the keywords and non-keywords;
determining a co-occurrence word of the keywords according to co-occurrence information of the keywords and the non-keywords in the standard question database;
mining a target question text from a pre-obtained target text set according to the co-occurrence word of the keywords.

By utilizing technical scheme of the embodiment of the present disclosure, the present disclosure obtains a pre-built standard question database. The standard question database comprises a first standard question text, and the first standard question text corresponds to the first intent category. According to the importance degree of each word of the first standard question text to the first intent category, a plurality of words are selected from the first standard question text (including keywords and non-keywords) to mine the keywords of the first intent category. In addition, the present disclosure could determine the co-occurrence of keywords according to the co-occurrence information of the keywords and the non-keywords in the standard question database. Since keywords are mined based on the importance of each word of the first standard question text to the first intent category, the keywords can reflect the first intent category of the first standard question text to a certain extent. Since the co-occurrence of keywords is determined based on the co-occurrence information of the keyword and the co-occurrence word of the standard question database, where the co-occurrence information is the information that appears in the same text. Therefore, the co-occurrence of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. For example, the same target question text includes both keywords and their co-occurrences, so that the keywords and co-occurrence words in the target question text can accurately reflect the corresponding intent categories of the target question text. Therefore, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question database.

According to an embodiment, a computer-readable storage medium is disclosed. The computer-readable storage medium stores one or more computer programs, and the computer program(s) comprise instructions. These instructions can be executed by an electronic device comprising a plurality of applications to enable the electronic device to perform operations comprising: obtaining a pre-built standard question database, where the standard question database comprises a first standard question text, the first standard question text corresponds to a first intent category, and the first standard question text comprises a plurality of words;
mining keywords of the first intent category from the plurality of words according to an importance degree of each word of the first standard question text to the first intent category, wherein the plurality of words comprise the keywords and non-keywords;
determining a co-occurrence word of the keywords according to co-occurrence information of the keywords and the non-keywords in the standard question database;
mining a target question text from a pre-obtained target text set according to the co-occurrence word of the keywords.

By utilizing technical scheme of the embodiment of the present disclosure, the present disclosure obtains a pre-built standard question database. The standard question database comprises a first standard question text, and the first standard question text corresponds to the first intent category. According to the importance degree of each word of the first standard question text to the first intent category, a plurality of words are selected from the first standard question text (including keywords and non-keywords) to mine the keywords of the first intent category. In addition, the present disclosure could determine the co-occurrence of keywords according to the co-occurrence information of the keywords and the non-keywords in the standard question database. Since keywords are mined based on the importance of each word of the first standard question text to the first intent category, the keywords can reflect the first intent category of the first standard question text to a certain extent. Since the co-occurrence of keywords is determined based on the co-occurrence information of the keyword and the co-occurrence word of the standard question database, where the co-occurrence information is the information that appears in the same text. Therefore, the co-occurrence of the keyword can be understood as the words with a high degree of relevance to the keyword (such as co-occurrence in the same standard question text). Then, according to the keywords of the first intent category and the co-occurrence words of the keywords, the target question text could be mined from the pre-obtained target text set. For example, the same target question text includes both keywords and their co-occurrences, so that the keywords and co-occurrence words in the target question text can accurately reflect the corresponding intent categories of the target question text. Therefore, the target question text has a high semantic generalization and corresponds to an accurate intent category, and the effect of mining high-quality target question text from the target text set is realized. In addition, since the mining process of the target question text does not require human participation, this automated question mining method can reduce a large workload for users (such as operators) and is conducive to quickly and accurately expanding the standard question database.

The system, device, module, or unit illustrated in the above embodiment may be embodied by a computer chip or entity, or by a product with a certain function. A typical implementation device is a computer. Specifically, computers can be, for example, personal computers, laptops, cellular phones, camera phones, smartphones, personal digital assistants, media players, navigation devices, e-mail devices, gaming consoles, tablets, wearables, or any combination of these devices.

For the convenience of description, the above devices are described separately by function. The functions of the units may be implemented in the same software and/or hardware in the present disclosure.

Those skilled in the art should understand that embodiments of the present disclosure may be provided as a method, system, or computer program product. Therefore, the present disclosure may take the form of a complete hardware embodiment, a complete software embodiment, or a combination of software and hardware embodiments. Further, the application may take the form of a computer program product implemented on one or more computer-available storage media (including, but not limited to, disk memory, CD-ROM, optical memory, etc.) containing computer-available program code.

The present disclosure is described with reference to a flowchart and/or block diagram of a method, apparatus (system), and computer program product according to the embodiment of the present disclosure. It should be understood that each process and/or block in the flowchart and/or block diagram, as well as the combination of the process and/or block in the flowchart and/or block diagram, can be implemented by computer program instructions. These computer program instructions may be provided to the processor of a general-purpose computer, a specialized computer, an embedded processing machine, or other programmable data processing device to produce a machine such that the instructions executed by the processor of the computer or other programmable data processing device produce a device for implementing the functions specified in one or more processes and/or block diagrams, one or more boxes.

These computer program instructions may also be stored in computer-readable memory capable of directing a computer or other programmable data-processing device to work in a particular manner such that the instructions stored in the computer-readable memory result in a manufactured product comprising a directive device that implements the functions specified in a flowchart process or processes and/or block diagram boxes or boxes.

These computer program instructions may also be loaded onto a computer or other programmable data processing device such that a series of operational steps are performed on the computer or other programmable device to produce computer-implemented processing, so that the instructions executed on the computer or other programmable device provide steps for implementing the function specified in a flowchart process or processes and/or block diagram boxes or boxes.

In a typical configuration, a computing device include one or more processors (CPUs), input/output interfaces, network interfaces, and one or more memory.

The memory may include a non-transitory memory, random access memory (RAM), and/or non-volatile memory in computer-readable media, such as read-only memory (ROM) or flash memory. The memory is an example of a computer-readable medium.

The computer-readable media include permanent and non-permanent, removable and non-removable media, and information storage can be achieved by any method or technology. Information can be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM (CD-ROM), digital multi-function disc (DVD).or other optical storage, magnetic cartridge tape, magnetic disk storage or other magnetic storage device or any other non-transmitting medium that may be used to store information that can be accessed by a computing device. As defined in this article, computer-readable media does not include computer-readable media, such as modulated data signals and carriers.

It should also be noted that the term “comprise”, “include” or any other variation thereof is intended to cover non-exclusive inclusion so that a process, process, goods or apparatus that includes a series of elements includes not only those elements, but also other elements that are not expressly listed, or that are inherent to such process, process, products or apparatus. In the absence of further restrictions, the element qualified by the phrase “comprising a . . . ” does not preclude the existence of other identical elements in the process, method, products or apparatus that includes the element.

The present disclosure can be described in the general context of a computer-executable instruction executed by a computer, such as a program module. In general, a program module includes routines, programs, objects, components, data structures, and so on that perform a specific task or implement a specific abstract data type. The present disclosure may also be practiced in distributed computing environments where tasks are performed by remote processing devices connected through a communication network. In a distributed computing environment, program modules can be located in local and remote computer storage media, including storage devices.

Each embodiment in the present disclosure is described in a progressive manner, and the same and similar parts between each embodiment can refer to each other, and each embodiment focuses on the differences from other embodiments. In particular, for the system embodiment, because it is basically similar to the method embodiment, the description is relatively simple, and the relevant places can be described in part of the method embodiment.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A question-mining method, comprising:
obtaining a pre-built standard question database; wherein the standard question database comprises a first standard question text, the first standard question text corresponds to a first intent category, and the first standard question text comprises a plurality of words;
mining keywords of the first intent category from the plurality of words according to an importance degree of each word of the first standard question text corresponding to the first intent category, wherein the plurality of words comprise the keywords and non-keywords;
determining a co-occurrence word of the keywords according to co-occurrence information of the keywords and the non-keywords in the standard question database; and
mining a target question text from a pre-obtained target text set according to the co-occurrence word of the keywords.

2. The method of claim 1, wherein the mining keywords of the first intent category from the plurality of words according to the importance degree of each word of the first standard question text to the first intent category comprises:
determining a target long text corresponding to the first intent category according to the first standard question text, wherein the target long text comprises at least one first standard question text;
determining a first occurrence information of each word of the target long text in the target long text, and determining a second occurrence information of each word of the target long text in the standard question database;
determining an importance degree of each word of the target long text corresponding to the first intent category according to the first occurrence information and the second occurrence information; and
mining the keywords of the first intent category from the plurality of words according to the importance degree of each word of the target long text corresponding to the first intent category, wherein the importance degrees of the keywords are higher than or equal to a preset importance degree threshold.

3. The method of claim 2, wherein the first occurrence information comprises an occurrence frequency and the determining the first occurrence information of each word of the target long text in the target long text, comprising:
determining a first occurrence number of a first word of the target long text; wherein the first word is any word of the target long text; and
determining the occurrence frequency of the first word of the target long text according to first occurrence number and a total number of words of the target long text.

4. The method of claim 2, wherein the second occurrence information comprises an inverse document frequency and the determining the second occurrence information of each word of the target long text in the standard question database comprises:
determining a first text number of the target long text corresponding to each intent category in the standard question database that comprises a second word;
determining the inverse document frequency corresponding to the second word according to the first text number and a total number of texts of the target long text.

5. The method of claim 1, wherein the co-occurrence information comprises a co-occurrence degree, and the determining a co-occurrence word of the keywords according to the co-occurrence information of the keywords and the non-keywords in the standard question database comprises:
determining a second text number of the standard question text that comprises the keywords in N standard question texts; and determining a third text number of the standard question texts that comprise both the keywords and the non-keywords in the N standard question texts;
determining the co-occurrence degree of the keywords and the non-keywords in the standard question database according to the second text number, the third text number and the total number of the N standard question texts; and
determining that the non-keywords as the co-occurrence words in response to that the co-occurrence degree of the keywords and the non-keywords is greater than or equal to a preset threshold.

6. The method of claim 1, wherein the mining the target question text from the pre-obtained target text set according to the co-occurrence word of the keywords comprises:
screening a candidate question text from the target text set; wherein the candidate question text comprises both the keywords and the non-keywords;
predicting the intent category to which the candidate question text belongs, and obtaining a prediction result of the candidate question text;
determining whether the candidate question text is the target question text according to the prediction result.

7. The method of claim 6, wherein the prediction result comprises a first prediction intent category and the predicting the intent category to which the candidate question text belongs and obtaining a result of the candidate question text comprises:
clustering the N standard question texts to obtain a clustering result, wherein the clustering result comprises a plurality of question text sets, and each of the question text sets comprises a plurality of the standard question texts;
determining a central question text for each of the question text sets, wherein the central question text is the standard question text closest to a clustering center corresponding to the question text set;
from a plurality of central question texts, selecting a central question text with a highest degree of similarity with the candidate question text; and
determining the intent category of the central question text with the highest similarity with the candidate question text as the first prediction intent category.

8. The method of claim 7, wherein the determining whether the candidate question text is the target question text according to the prediction result comprises:
in response to that the first prediction intent category is the same as the intent category corresponding to the keyword, determining the candidate question text as the target question text; and
in response to that the first prediction intent category and the intent category corresponding to the keyword are different, determining the candidate question text not to be the target question text.

9. The method of claim 6, wherein the prediction result comprises: a probability that the candidate question text belongs to each intent category, and the predicting the intent category to which the candidate question text belongs, and obtaining a prediction result of the candidate question text comprises:
using a pre-trained intent recognition model to predict the intent category to which the candidate question text belongs, and obtaining the probability that the candidate question text belongs to each intent category; wherein the intent recognition model is obtained by training according to sample question texts and sample intent categories of the sample question texts.

10. The method of claim 9, wherein the determining whether the candidate question text is the target question text according to the prediction result comprises:
calculating an information entropy of the candidate question text according to the probability that the candidate question text belongs to each intent category;
in response to that the information entropy is greater than or equal to the preset information entropy threshold, determining the candidate question text to be the target question text;
in response to that the information entropy is less than the preset information entropy threshold, determining the candidate question text not to be the target question text.

11. An electronic device, comprising a processor and a memory electrically connected to the processor, wherein the memory stores a computer program, and the processor is configured to execute the computer program stored the memory to perform operations comprising:
obtaining a pre-built standard question database; wherein the standard question database comprises a first standard question text, the first standard question text corresponds to a first intent category, and the first standard question text comprises a plurality of words;
mining keywords of the first intent category from the plurality of words according to an importance degree of each word of the first standard question text corresponding to the first intent category, wherein the plurality of words comprise the keywords and non-keywords;
determining a co-occurrence word of the keywords according to co-occurrence information of the keywords and the non-keywords in the standard question database; and
mining a target question text from a pre-obtained target text set according to the co-occurrence word of the keywords.

12. The electronic device of claim 11, wherein an operation of mining keywords of the first intent category from the plurality of words according to the importance degree of each word of the first standard question text to the first intent category comprises:
determining a target long text corresponding to the first intent category according to the first standard question text, wherein the target long text comprises at least one first standard question text;
determining a first occurrence information of each word of the target long text in the target long text, and determining a second occurrence information of each word of the target long text in the standard question database;
determining an importance degree of each word of the target long text corresponding to the first intent category according to the first occurrence information and the second occurrence information; and
mining the keywords of the first intent category from the plurality of words according to the importance degree of each word of the target long text corresponding to the first intent category, wherein the importance degrees of the keywords are higher than or equal to a preset importance degree threshold.

13. The electronic device of claim 12, wherein the first occurrence information comprises an occurrence frequency and the determining the first occurrence information of each word of the target long text in the target long text, comprising:
determining a first occurrence number of a first word of the target long text; wherein the first word is any word of the target long text; and
determining the occurrence frequency of the first word of the target long text according to first occurrence number and a total number of words of the target long text.

14. The electronic device of claim 12, wherein the second occurrence information comprises an inverse document frequency and the determining the second occurrence information of each word of the target long text in the standard question database comprises:
determining a first text number of the target long text corresponding to each intent category in the standard question database that comprises a second word;
determining the inverse document frequency corresponding to the second word according to the first text number and a total number of texts of the target long text.

15. The electronic device of claim 11, wherein the co-occurrence information comprises a co-occurrence degree, and the determining a co-occurrence word of the keywords according to the co-occurrence information of the keywords and the non-keywords in the standard question database comprises:
determining a second text number of the standard question text that comprises the keywords in N standard question texts; and determining a third text number of the standard question texts that comprise both the keywords and the non-keywords in the N standard question texts;
determining the co-occurrence degree of the keywords and the non-keywords in the standard question database according to the second text number, the third text number and the total number of the N standard question texts; and
determining that the non-keywords as the co-occurrence words in response to that the co-occurrence degree of the keywords and the non-keywords is greater than or equal to a preset threshold.

16. The electronic device of claim 11, wherein the mining the target question text from the pre-obtained target text set according to the co-occurrence word of the keywords comprises:
screening a candidate question text from the target text set; wherein the candidate question text comprises both the keywords and the non-keywords;
predicting the intent category to which the candidate question text belongs, and obtaining a prediction result of the candidate question text;
determining whether the candidate question text is the target question text according to the prediction result.

17. The electronic device of claim 16, wherein the prediction result comprises a first prediction intent category and the predicting the intent category to which the candidate question text belongs and obtaining a prediction result of the candidate question text comprises:
clustering the N standard question texts to obtain a clustering result, wherein the clustering result comprises a plurality of question text sets, and each of the question text sets comprises a plurality of the standard question texts;
determining a central question text for each of the question text sets, wherein the central question text is the standard question text closest to a clustering center corresponding to the question text set;
from a plurality of central question texts, selecting a central question text with a highest degree of similarity with the candidate question text; and
determining the intent category of the central question text with the highest similarity with the candidate question text as the first prediction intent category.

18. The electronic device of claim 17, wherein the determining whether the candidate question text is the target question text according to the prediction result comprises:
in response to that the first prediction intent category is the same as the intent category corresponding to the keyword, determining the candidate question text as the target question text; and
in response to that the first prediction intent category and the intent category corresponding to the keyword are different, determining the candidate question text not to be the target question text.

19. The electronic device of claim 16, wherein the prediction result comprises: a probability that the candidate question text belongs to each intent category, and the predicting the intent category to which the candidate question text belongs, and obtaining a prediction result of the candidate question text comprises:
using a pre-trained intent recognition model to predict the intent category to which the candidate question text belongs, and obtaining the probability that the candidate question text belongs to each intent category; wherein the intent recognition model is obtained by training according to sample question texts and sample intent categories of the sample question texts.

20. A non-transitory computer-readable storage medium, wherein the storage medium stores a computer program, and the computer program is executed by a processor to perform operations comprising:
obtaining a pre-built standard question database; wherein the standard question database comprises a first standard question text, the first standard question text corresponds to a first intent category, and the first standard question text comprises a plurality of words;
mining keywords of the first intent category from the plurality of words according to an importance degree of each word of the first standard question text corresponding to the first intent category, wherein the plurality of words comprise the keywords and non-keywords;
determining a co-occurrence word of the keywords according to co-occurrence information of the keywords and the non-keywords in the standard question database; and
mining a target question text from a pre-obtained target text set according to the co-occurrence word of the keywords.
